(19) United States
(12) Patent Application Publication
(10) Pub. No.: US 2005/0116987 A1
(43) Pub. Date: Jun. 2, 2005

(54) METHOD FOR PREVENTING AIR FROM PRESSING INTO A PRINT NOZZLE OF AN INK CONTAINER USING NEGATIVE PRESSURE

(76) Inventor: Shih-Yen Chang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,625

(22) Filed: Nov. 19, 2004

(30) Foreign Application Priority Data
Nov. 28, 2003 (TW) 092133520

(51) Int. Cl. B41J 2/165

(52) U.S. Cl. 347/30

(57) ABSTRACT

A method for preventing air from pressing into a print nozzle of an ink container of a printer is proposed. The printer includes a pressure-generating module and a capping module. The method includes generating local pressure nearby the print nozzle of the ink container with the pressure-generating module when the capping module caps the print nozzle and capping the print nozzle with the capping module for separating the print nozzle from the air outside the capping module.

### BACKGROUND OF INVENTION

1. Field of the Invention

The present invention relates to a method for preventing air from pressing into a print nozzle of an ink container, and more particularly, to a method for preventing air from pressing into a print nozzle of an ink container using negative pressure.

2. Description of the Prior Art

As personal computers become more popular, ink jet printing devices are becoming a common computer output/printing device used by people, families, and companies because a price and quality of the ink jet printers attract customers. However the high level of printing quality also depends on how to preserve the print head effectively.

A typical ink jet printing device has a print head that moves along a track, back and forth, to print on a document. The print head usually has at least an ink cartridge, and the ink cartridge includes a housing with an ink reservoir for storing ink and a print head connected to the ink reservoir to control the ink jetting. In a typical ink jet printing device, flow control is usually employed to control the ink jetting out to the document from the ink reservoir. Typical print head flow control mechanisms are divided into two types: thermal-bubbles and pressure-waves. The thermal-bubbles print head includes a thin-film resister. When the resistor is heated, a trace of ink vaporizes immediately, quickly expanding to make ink pass through the print head and print on the document. Although the print head using the flow control can get ink from the ink reservoir and jet ink effectively, the flow control needs a controlling mechanism, so that the print head does not seep ink when not in use. The controlling mechanism usually provides a light negative pressure to prevent ink from seeping onto the print head. The negative pressure is a partial vacuum in the ink cartridge, so that the external atmospheric pressure is slightly higher than the fluid pressure in the ink cartridge. The negative pressure is indicated by a positive value, so an increase in the negative pressure means an increased vacuum of the ink cartridge and a greater difference between the external atmospheric pressure and the fluid pressure in the cartridge. By increasing the negative pressure, ink is prevented from seeping from the print head. Although increasing the negative pressure prevents ink from seeping out of the print head, the negative pressure has an upper limit. If the negative pressure is too high, ink cannot overcome the negative pressure and cannot jet from the print head. Moreover, if the external atmospheric pressure is much greater than the fluid pressure in the cartridge, the external atmospheric pressure will overcome the fluid pressure in the cartridge and the external air will seep into the print head in bubble form. Therefore the ink channel will be clogged and the print quality will be lowered.

In addition, the current manufacturers often provide a capping mechanism for the print head to prevent ink from vaporizing. However, if the capping mechanism causes too much negative pressure in the cartridge, there is often unwanted air that is compressed into the print head. Therefore the ink channel will be clogged and the print quality will be lowered.

### SUMMARY OF INVENTION

It is therefore a primary objective of the present invention to provide a method for preventing air from pressing into a print nozzle of an ink container to solve the above-mentioned problems.

According to the claimed invention, a method for preventing air from pressing into a print nozzle of an ink container of a printer is proposed. The printer includes a pressure-generating module and a capping module. The method includes generating local pressure nearby the print nozzle of the ink container with the pressure-generating module when the capping module caps the print nozzle and capping the print nozzle with the capping module for separating the print nozzle from the air outside the capping module.

According to the claimed invention, a printer includes a housing and an ink container installed inside the housing. The ink container includes a pressure-generating module. The printer also includes a capping module installed inside the housing for capping a print nozzle of the ink container and a control unit for controlling the pressure-generating module to generate local pressure nearby the print nozzle of the ink container when the capping module caps the print nozzle.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a printer according to the present invention.

FIG. 2 is a diagram of an ink container according to the present invention.

FIG. 3 is a sectional drawing of the ink container along the axis 3-3′.

FIG. 4 is a flowchart illustrating that air is prevented from pressing into a print nozzle of the ink container of the printer according to the present invention.

### DETAILED DESCRIPTION

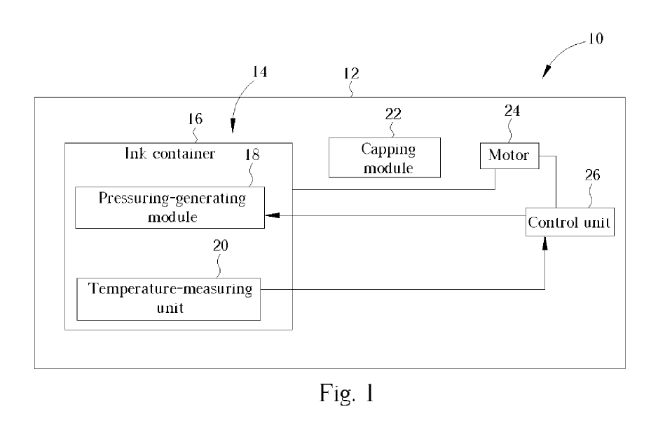

Please refer to FIG. 1. FIG. 1 is a functional block diagram of a printer 10 according to the present invention. The printer 10 includes a housing 12 and an ink container 14 installed inside the housing 12. The ink container 12 includes a casing 16, a pressure-generating module 18, and a temperature-measuring unit 20. The pressure-generating module 18 can be a heating module or an electrothermal transducer for transforming electric energy into heat energy, like an electrothermal chip including a thermal resistance. The temperature-measuring unit 20 can measure the heating temperature of the ink container 14 and transmit the heating temperature to the printer 10. The printer 10 also includes a capping module 22 installed inside the housing 12 for capping a print nozzle of the ink container 14 and a motor 24 for moving the ink container 14 back and forth to print on a document. The motor 24 can be a DC motor. The printer 10 further comprises a control unit 26 for controlling the pressure-generating module 18 to generate local pressure nearby the print nozzle of the ink container 14 according to the heating temperature transmitted from the temperature-measuring unit 20 when the capping module 22 caps the print nozzle.

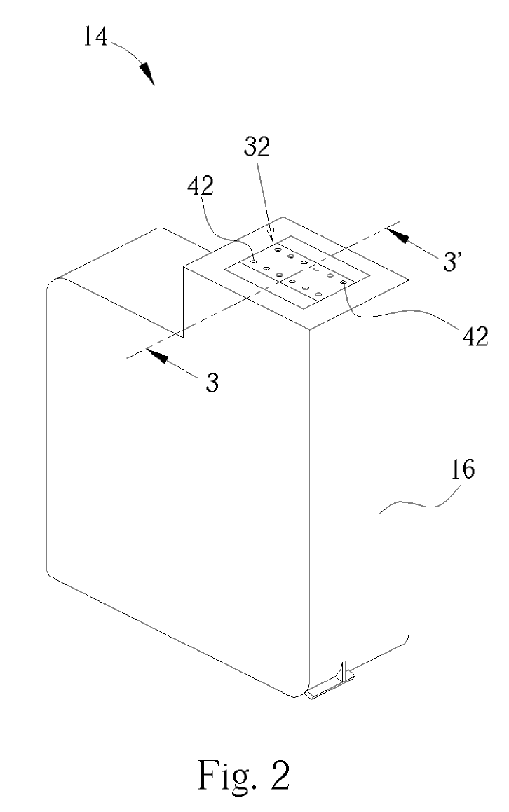

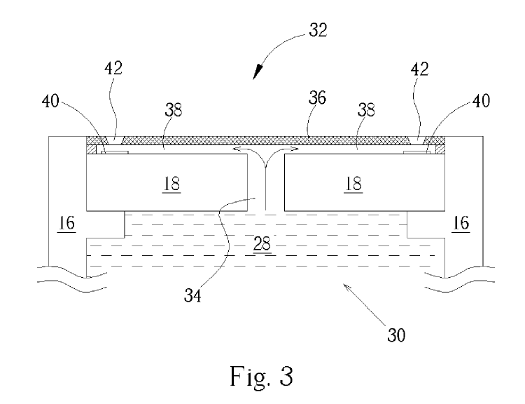

Please refer to FIG. 2 and FIG. 3. FIG. 2 is a diagram of the ink container 14 according to the present invention. FIG. 3 is a sectional drawing of the ink container 14 along the axis 3-3′. The ink container 16 includes the casing 16 for forming an ink reservoir 30 for storing ink 28. A print head 32 is installed on top of the ink container 14 and connected to the ink reservoir 30 for controlling the ink 28 jetting out to the document from the ink reservoir 30. The pressure-generating module 18 is installed inside the print head 32. The ink container 14 also includes a manifold 34. The print head 32 is connected to the ink reservoir 30 via the manifold 34. The print head 32 further includes an orifice layer 36. A plurality of ink chambers 38 is formed between the orifice layer 36 and the pressure-generating module 18. The pressure-generating module 18 includes a plurality of heating units 40, and each heating unit 40 is utilized for heating the ink 28 in a corresponding ink chamber 38 to generate bubbles. The orifice layer 36 includes a plurality of print nozzle 42, and each print nozzle 42 is located in a position corresponding to one heating unit 40. When the electric current passes through the heating unit 40 so that the heating unit 40 can heat the ink 28 in the ink chamber 38 to generate bubbles, the ink 28 will be jetted from the print nozzle 42.

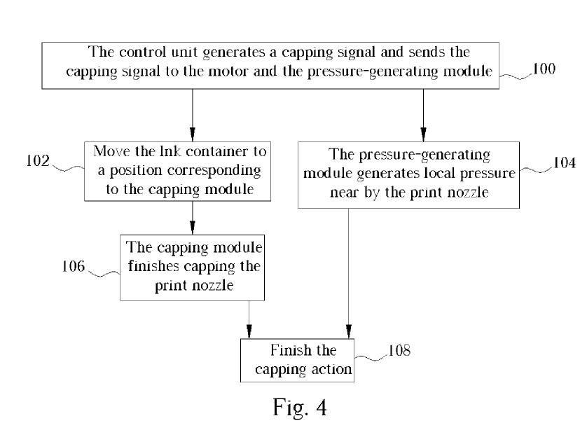

Please refer to FIG. 4. FIG. 4 is a flowchart illustrating that air is prevented from pressing into the print nozzle 42 of the ink container 14 of the printer 10 according to the present invention. The method includes:
Step 100: The control unit 26 generates a capping signal and sends the capping signal to the motor 24 and the pressure-generating module 18 of the ink container 14. Proceed to step 102 and step 104;
Step 102: Move the ink container 14 to a position corresponding to the capping module 22 so that the capping module 22 can cap the print nozzle 42 of the ink container 14. Go to step 106;
Step 104: The pressure-generating module 18 generates local pressure nearby the print nozzle 42 of the ink container 14 when the capping module 22 caps the print nozzle 42 of the ink container 14. Go to step 108;
Step 106: The capping module 22 finishes capping the print nozzle 42 of the ink container 14 for separating the print nozzle 42 from air outside the capping module 22; and
Step 108: Finish the capping action.

The detailed description is as follows. When the ink container 14 finishes the printing job, the ink container 14 will be back to an original location that is usually located on either side of the printer 10. At this time the capping module 22 will cap the print nozzle 42 of the ink container 14 to prevent the ink 28 from vaporizing from the print nozzle 42. The control unit 26 of the printer 10 will generate a capping signal and send the capping signal to the motor 24 and the pressure-generating module 18 of the ink container 14. When the motor 24 receives the capping signal, the motor 24 will move the ink container 14 to a position corresponding to the capping module 22 so that the capping module 22 can cap the print nozzle 42 of the ink container 14. Simultaneously the pressure-generating module 18 will generate local pressure nearby the print nozzle 42 of the ink container 14. The method of generating local pressure can be that the heating unit 40 heats the ink 28 nearby to increase the temperature. The working principle is according to the ideal gas equation PV=nRT (P: gas pressure; V: gas volume; n: mole number of gas; R: Avogadro's number; T: temperature of gas). When the air nearby the print nozzle 42 is heated for increasing its temperature, the pressure of the air nearby the print nozzle 42 will be increased for generating local pressure. The increasing pressure can resist the capping pressure of the capping module 22, so the air outside the capping module 22 can be prevented from pressing into the print nozzle 42 of the ink container 14. Therefore there is less air clogging in the ink channel of the print nozzle 42. The print quality will be increased because the accuracy of the jetting direction and the success rate of jetting the ink 28 from the print nozzle 42 are increased and the size of jetting bubbles can be controlled effectively.

Besides the method mentioned above, the ink 28 nearby the heating unit 40 can be heated by the heating unit 40 to raise the temperature nearby the print nozzle 42 of the ink container 14, and some ink 28 can be jetted from the print nozzle 42 for generating local pressure. Therefore not only will the pressure of the air nearby the print nozzle 42 be increased for generating local pressure, but also a hydraulic pressure will be generated nearby the print nozzle 42 of the ink container 14 for preventing the air outside the capping module 22 from pressing into the print nozzle 42 of the ink container 14. The hydraulic pressure is generated from the ink inside the print nozzle 42. So when the ink 28 is jetted outside the print nozzle 42, the original bubbles inside the print nozzle 42 will be jetted outside the print nozzle 42 too. The operating mechanism of the pressure-generating module 18 is not limited to the heating mechanism mentioned above. The pressure-generating module 18 also can be a piezoelectricity transducer for transforming electric energy into mechanical energy so as to pressurize ink inside the ink channel of the ink container 14 and air nearby the print nozzle 42. For example, the pressure-generating module 18 can be made of piezoelectricity material for transforming electric energy into energy of deformation so as to pressurize ink inside the ink channel of the ink container 14 and air nearby the print nozzle 42 when the energy of deformation stored in the piezoelectricity material is released.

When the pressure-generating module 18 generates local pressure nearby the print nozzle 42 of the ink container 14, the ink container 14 will move to the position corresponding to the capping module 22 and then the capping module 22 will finish capping the print nozzle 42 of the ink container 14 for separating the print nozzle 42 from air outside the capping module 22. Therefore it can prevent dirt outside from entering the print nozzle 42 and prevent the ink 28 from vaporizing from the print nozzle 42. Thus the capping job is finished.

In contrast to the prior art, the printer 10 according to the present invention can utilize the pressure-generating module 18 to generate local pressure nearby the print nozzle 42 of the ink container 14 for preventing unwanted air outside from pressing into the print nozzle 42 of the ink container 14 and for preventing the ink channel from becoming clogged by bubbles when the capping module 22 caps the print nozzle 42 of the ink container 14. Furthermore, compared with the prior method of preventing outside air from pressing into the print nozzle 42, utilizing the heating mechanism for generating local pressure according to the present invention can allow the present invention to be implemented under the current structure of present ink jet printing devices. The present invention also can be applied to other image printing devices in ink jet printing technology, like fax machines or multi-function products. Any method for preventing air from pressing into the print nozzle 42 of the ink container 14 using negative pressure is all within the scope of the present invention.

Those skilled in the art will readily observe that numerous modifications and alterations of the method and the device may be made while retaining the teachings of the invention. Accordingly, the above disclosure should be construed as limited only by the metes and bounds of the appended claims.

1. A method for preventing air from pressing into a print nozzle of an ink container of a printer, the printer comprising a pressure-generating module and a capping module, the method comprising:
(a) generating local pressure nearby the print nozzle of the ink container with the pressure-generating module when the capping module caps the print nozzle; and
(b) capping the print nozzle with the capping module for separating the print nozzle from the air outside the capping module.

2. The method of claim 1, wherein in step (a) the ink nearby the pressure-generating module is heated to raise the temperature nearby the print nozzle of the ink container for generating local pressure when the capping module caps the print nozzle.

3. The method of claim 1, wherein in step (a) the ink nearby the pressure-generating module is heated to raise the temperature nearby the print nozzle of the ink container and is jetted from the print nozzle for generating local pressure when the capping module caps the print nozzle.

4. The method of claim 1, wherein in step (a) the pressure-generating module pressures the ink nearby the pressure-generating module for generating local pressure nearby the print nozzle of the ink container when the capping module caps the print nozzle.

5. The method of claim 1 further comprising moving the ink container to a position corresponding to the capping module so that the capping module can cap the print nozzle when step (a) is proceeding.

6. An apparatus for implementing the method of claim 1.

7. A printer comprising:
a housing;
an ink container installed inside the housing, the ink container comprising a pressure-generating module;
a capping module installed inside the housing for capping a print nozzle of the ink container; and
a control unit for controlling the pressure-generating module to generate local pressure nearby the print nozzle of the ink container when the capping module caps the print nozzle.

8. The printer of claim 7, wherein the pressure-generating module is a heating module for heating the ink container.

9. The printer of claim 7, wherein the pressure-generating module is an electrothermal transducer for transforming electric energy into heat energy so as to heat ink inside an ink channel of the ink container and air nearby the print nozzle.

10. The printer of claim 9, wherein the electrothermal transducer is an electrothermal chip.

11. The printer of claim 7, wherein the pressure-generating module is a piezoelectricity transducer for transforming electric energy into mechanical energy so as to pressurize ink inside an ink channel of the ink container and air nearby the print nozzle.
